(19) United States
(12) Patent Application Publication
(10) Pub. No.: US 2006/0083212 A1
(43) Pub. Date: Apr. 20, 2006

(54) Method and apparatus for network-initiated packet data service reactivation

(76) Inventors: Erik Colban, San Diego, CA (US); Vibhor Julka, San Diego, CA (US)

Correspondence Address: COATS & BENNETT, PLLC, P O BOX 5, RALEIGH, NC, 27602, US

(21) Appl. No.: 11/253,428

(22) Filed: Oct. 19, 2005

Related U.S. Application Data
(60) Provisional application No. 60/620,487, filed on Oct. 20, 2004.

(51) Int. Cl. H04J 3/24

(52) U.S. Cl. 370/349

(57) ABSTRACT

One or more entities of a wireless communication network distribute address information for a source Packet Data Serving Node (PDSN) to the packet zones involved in reactivation paging of a dormant mobile station for network-initiated packet data delivery. A target Packet Control Function (PCF) supporting the packet zone in which the mobile station responded to the reactivation paging uses the address information to reactive packet data service to the mobile station through the source PDSN, if network connectivity permits. For example, the target PCF uses the source PDSN's IP address to send a registration request for the mobile station to the source PDSN. If the source PDSN is not directly reachable through the target PCF, the target PCF may send the source PDSN's P-P address to a target PDSN, and target PDSN can attempt to connect to the source PDSN for reactivation of the mobile station's packet data service.

### RELATED APPLICATIONS

This application claims priority under 35 U.S.C. § 119(e) from U.S. provisional patent application Ser. No. 60/620,487 filed on 20 Oct. 2004. This application is expressly incorporated in its entirety by reference herein.

### BACKGROUND OF THE INVENTION

The present invention generally relates to packet-based wireless communication networks, and particularly relates to improved mobility management.

Packet-based wireless communication networks generally divide a service area into “packet zones” and direct data incoming to the network for a particular mobile station to the appropriate packet zone. In cdma2000 networks for example, Packet Data Serving Nodes (PDSNs) receive incoming packet data from the Internet or elsewhere and direct that data to Packet Control Functions (PCFs) corresponding to packet zones of the targeted mobile stations.

For dormant mobile stations, the conventional approach delivers packet data to the packet zone where the mobile station was last active, or where the mobile station last initiated a dormant handoff procedure. In dormant handoff, the mobile station recognizes that it has moved into a new packet zone and initiates a new PDSN registration.

Dormant handoff thus provides a mechanism for keeping the packet zone location of the mobile station updated during periods of inactivity, but the process has its disadvantages. Signaling overhead caused by ongoing dormant registrations stands out as one such disadvantage. Using smaller packet zone footprints improves some aspects of network implementation flexibility and mobility management, but exacerbates the dormant handoff signaling overhead problem.

Another disadvantage arises from an intended, partial fix for the signaling overhead problem. To avoid excessive dormant handoff signaling as mobile stations move along packet zone boundaries, the mobile stations may apply hysteresis in their dormant handoff algorithms. With hysteresis, a mobile station defers dormant handoff registration upon entering a new packet zone on the chance that it may quickly move back into its previous packet zone. Thus, at least for the deferral period, packet data targeted to the mobile station will be erroneously delivered to the previous packet zone.

### SUMMARY OF THE INVENTION

One embodiment of dormant mobile station reactivation as taught herein comprises a method of reactivating packet data service to a dormant mobile station for packet data delivery by a wireless communication network comprising one or more packet zones. The method comprises initiating reactivation paging of the mobile station responsive to receiving incoming packet data for the mobile station at a source Packet Data Serving Node (PDSN), providing address information for the source PDSN to a target Packet Control Function (PCF), and using the address information at the target Packet Control Function (PCF) to select, if network connectivity permits, the source PDSN for reactivation of packet data service to the mobile station. In this context, the source PDSN is the PDSN last associated with serving the mobile station, and the target PCF is the PCF supporting the packet zone in which the mobile station responded to the reactivation paging, e.g., the PCF associated with the base station that received the mobile station's paging response.

In another embodiment, a method of reactivating packet data service to a dormant mobile station for packet data delivery by a wireless communication network comprising one or more packet zones comprises receiving address information for a source PDSN at a target PCF. If network connectivity permits, the target PCF selects the source PDSN as identified by the received address information for reactivation of packet data service to the mobile station. Again, the target PCF is the PCF supporting the packet zone in which the mobile station responded to reactivation paging by the wireless communication network.

The address information may comprise the IP address of the source PDSN, for example, and may additionally include the P-P address of the source PDSN, which may be considered as an “anchor” address. In all cases, the address information identifies the source PDSN to the target PCF, and thus allows the target PCF to select the source PDSN, directly or indirectly, for reactivation of packet data service to the mobile station, which avoids the loss of data and significant signaling overhead that otherwise would occur if the target PCF simply initiated a new registration of the mobile station at a target PDSN different than the source PDSN.

If the source PDSN is directly reachable by the target PCF, it can reactivate packet data service for the mobile station through the source PDSN by sending a registration request to the source PDSN. As part of that registration process, the target PCF can be configured to provide a previous network identifier and a current network identifier for the mobile station, e.g., that information can be included in the registration request message sent to the source PDSN. The previous network identifier allows the source PDSN to determine that it already has packet data resources allocated for serving the mobile station, and thus prevents unnecessary re-registration of the mobile station.

If the source PDSN is not directly reachable by the target PCF, the target PCF can provide all or part of the address information for the source PDSN to a target PDSN, as selected by the target PCF. In turn, the target PDSN can use the P-P address of the source PDSN to establish a PDSN-to-PDSN (P-P) connection with the source PDSN. With that connection successfully established, the Point-to-Point Protocol (PPP) session for the mobile station is preserved at the source PDSN, and the mobile station's care-of routing address is unchanged.

Regardless of whether the source PDSN is directly reachable by the target PCF, the source PDSN can be configured to avoid loss of incoming packet data while the mobile station is being reactivated. More particularly, the source PDSN can be configured to initiate reactivation paging of the mobile station by sending one or more empty data frames to the source PCF in response to receiving incoming packet data for the mobile station. In other words, rather than passing the incoming packet data along to the source PCF as the initiating trigger for reactivation of the mobile station, the source PDSN sends empty or dummy data and buffers the actual incoming packet data. Using this approach, the buffered packet data can be sent from the source PDSN for delivery to the mobile station through the target PCF, once the packet data service with the mobile station has been reactivated.

By way of non-limiting example, the present invention may be implemented in cdma2000 1× wireless communication networks. In such embodiments, a source base station can be configured to receive the source PDSN's address information and to provide that address information to a Mobile Switching Center (MSC) involved in reactivation paging of the mobile station. In turn, the MSC can be configured to provide a target base station with the address information and, in turn, the target base station provides the address information to the target PCF for identification and selection of the source PDSN.

As another example, the present invention may be implemented in High Rate Packet Data (HRPD) networks. In such embodiments, MSCs are not used, but the PCFs include mobility management entities that are configured to send reactivation information (e.g., the source PDSN address information and the source PCF's Access Network Identifier or ANID) from source entities to target entities.

Of course, the present invention is not limited to the above features and advantages. Those skilled in the art will recognize additional features and advantages upon reading the following detailed description, and upon viewing the accompanying drawings.

### BRIEF DESCRIPTION OF THE DRAWINGS

FIG. 1 is a logic flow diagram of reactivation-triggered handoff according to one embodiment taught herein.

FIG. 2 is a logic flow diagram of packet data service reactivation details for the logic flow diagram of FIG. 1.

FIG. 3 is a simplified block diagram of a wireless communication network configured to perform reactivation-triggered handoff of a mobile station as part of network-initiated packet data delivery according to one embodiment taught herein.

FIG. 4 is a call flow diagram of reactivation-triggered handoff as carried out by the network of FIG. 3.

FIG. 5 is a simplified block diagram of a wireless communication network configured to perform reactivation-triggered handoff of a mobile station as part of network-initiated packet data delivery according to another embodiment taught herein.

FIGS. 6a and 6b are a call flow diagram for HRPD.

### DETAILED DESCRIPTION OF THE INVENTION

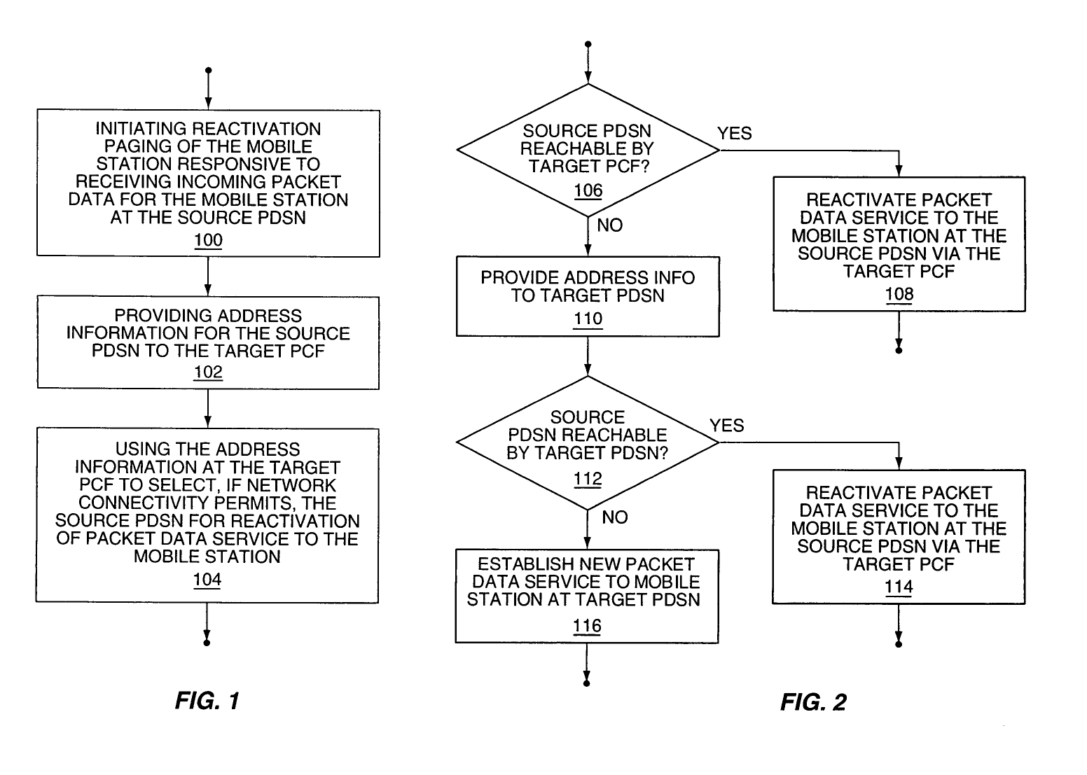

Broadly, the methods and apparatus taught herein provide for reactivating packet data service to dormant mobile stations for network-initiated packet data delivery in a manner that avoids having to perform dormant handoffs by the network as dormant mobile stations move among different packet zones of the network. That is, in one aspect, the methods and apparatus taught herein allow handoff of a dormant mobile station to be deferred until it is necessary to reactivate the mobile station for network-initiated packet data delivery to it. FIG. 1 sets out one embodiment of such “reactivation-triggered” handoff of a dormant mobile station.

The illustrated processing begins with initiating reactivation paging for a given dormant mobile station responsive to a source Packet Data Serving Node (PDSN) receiving incoming packet data for the mobile station (Step 100). In this context, the source PDSN generally is the PDSN that was last associated with serving the mobile station, i.e., the PDSN last anchoring the PPP session of the mobile station during active packet data service. Initiating reactivation paging may comprise sending one or more empty data frames from the source PDSN to a source Packet Control Function (PCF) last associated with serving the mobile station, while buffering the incoming packet data for subsequent delivery to the mobile station upon its reactivation. Alternatively, the source PDSN may send the actual incoming packet data to the source PCF to initiate reactivation paging.

In either case, the attempted data delivery initiates reactivation paging of the mobile station. As taught herein, the reactivation paging process includes providing address information for the source PDSN to a target PCF (Step 102). For example, the source PDSN may comprise one or more processing circuits configured to send address information, including at least one of its routing address and its P-P address, to the associated source PCF to support reactivation of the mobile station 12 for network-initiated packet data delivery.

In this context, the target PCF is the PCF supporting the packet zone in which the mobile station responds to the reactivation paging. The target PCF will not be the source PCF if the mobile station moved into another packet zone while dormant. Processing continues with the target PCF using the address information to select, if network connectivity permits, the source PDSN for reactivation of packet data service to the mobile station (Step 104).

That is, the target PCF may comprise one or more processing circuits configured to receive address information for source Packet Data Serving Node (PDSN) last associated with serving a mobile station. As part of reactivating the mobile station for network-initiated packet data delivery, the target PCF is configured to select the source PDSN as identified by the received address information for reactivation of packet data service to the mobile station if network connectivity permits.

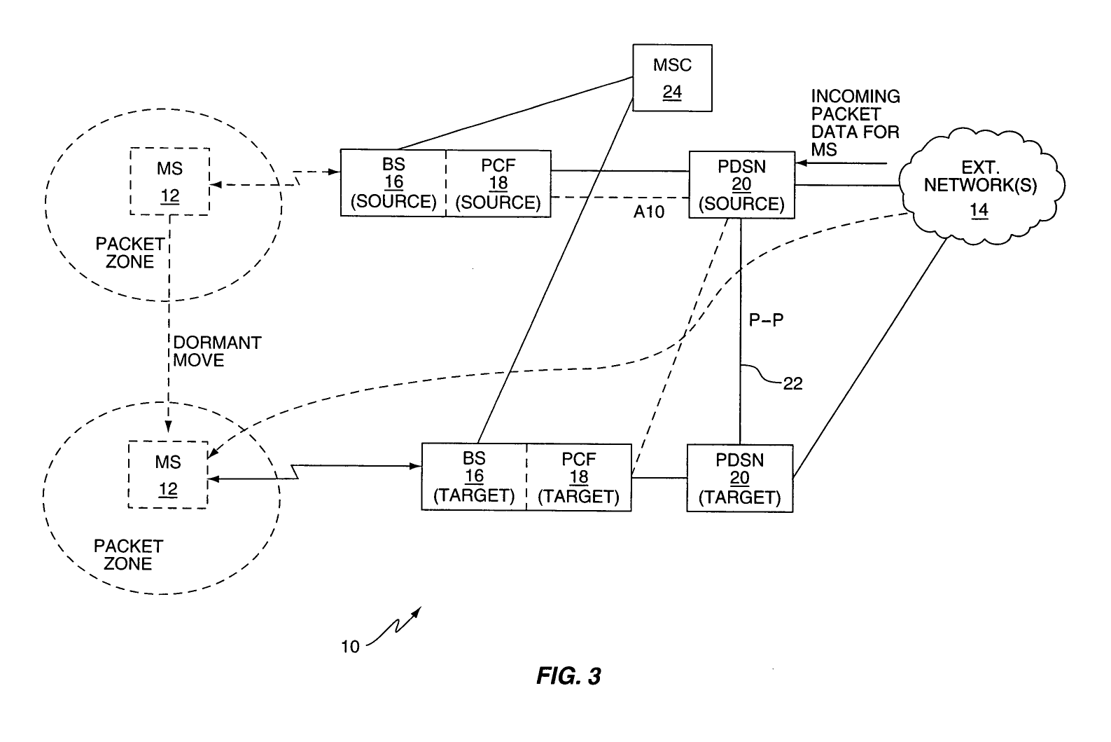

FIG. 2 illustrates one embodiment for re-establishing packet data service to the mobile station through the source PDSN as conditioned on the connectivity between the target PCF and the source PDSN. According to the illustrated processing logic, if the source PDSN is (directly) reachable by the target PCF (Step 106), the target PCF reactivates packet data service to the mobile station at the source PDSN by sending the appropriate registration messages (Step 108). To this end, the address information received at the target PCF may include the routing (Internet Protocol (IP)) address of the source PDSN, which is used by the target PCF to identify the source PDSN for transmission of the registration messages.

If the source PDSN is not (directly) reachable by the target PCF, the target PCF may provide address information for the source PDSN to a target PDSN (Step 110). To this end, the address information received for the source PDSN at the target PCF may include the P-P address of the source PDSN. The target PDSN attempts to establish a PDSN-to-PDSN (P-P) connection with the source PDSN using the P-P address information (Step 112). If the target PDSN successfully establishes a P-P connection with the source PDSN, packet data service to the mobile station is reactivated at the source PDSN via the target PCF (Step 114).

Whether the target PCF directly communicates with the source PDSN, or whether it indirectly communicates with the source PDSN through a P-P connection established through the target PDSN, the established data connection(s) at the source PDSN are reactivated for delivery of the incoming packet data to the mobile station. Doing so avoids the unnecessary signaling burden associated with establishing a new PPP session at the target PDSN rather than retaining the PPP session at the source PDSN, and also avoids the potential loss of data, delays, and possible disruption of higher-layer data protocols that are associated with changing the mobile station's PPP anchor point from the source PDSN to a new target PDSN.

Of course, if the source PDSN is not directly or indirectly reachable by the target PCF, the target PCF establishes new packet data service to the mobile station at the target PDSN (Step 116). Establishing new packet date service to the mobile station at the target PDSN generally entails negotiating a new PPP session and conducting foreign agent advertisement procedures so that subsequently incoming data for the mobile station goes to the new target PDSN.

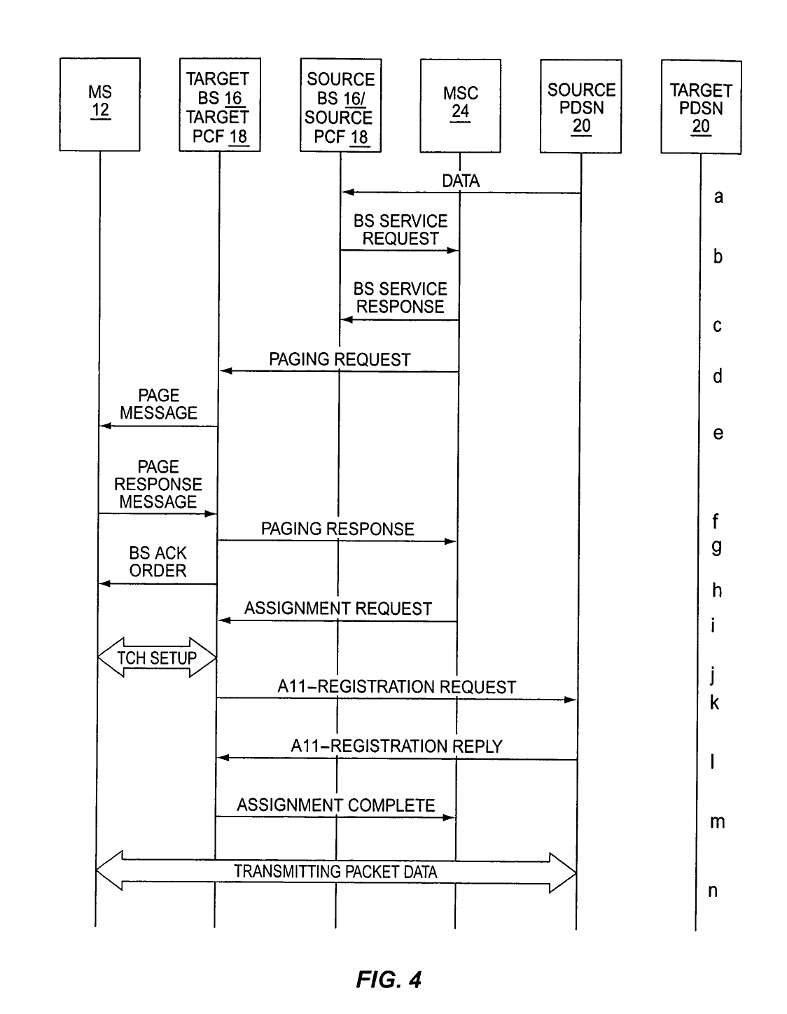

FIG. 3 illustrates a cdma2000 1× embodiment of a wireless communication network 10, which communicatively couples a mobile station 12 to one or more external networks 14 (i.e., the Internet). The illustrated embodiment of the network 10 comprises one or more base stations 16, one or more PCFs 18, one or more PDSNs 20, which may be communicatively linked through P-P connections 22, and one or more Mobile Switching Centers (MSCs) 24.

Packet data service as provided by the network 10 generally is organized in terms of packet zones, which may correspond to the coverage areas of its PCFs 18. That is, as the mobile station 12 moves from one packet zone to another, its packet data traffic must be routed through different PCFs 18 and, potentially, through different PDSNs 20. Keeping track of such movement can be challenging, particularly when the mobile station 12 is dormant (i.e., when it is not actively sending or receiving packet data traffic).

Advantageously, according to the methods and apparatus taught herein, the network 10 does not need to track the mobile station 12 as it moves between packet zones while dormant. Instead, at least for network-initiated packet data delivery to the mobile station 12, the network 10 performs a “deferred handoff” of the mobile station, wherein the network 10 performs a reactivation-triggered handoff of the mobile station 12. Simply put, the network 10 “finds” the mobile station's current packet zone location as part of reactivating the mobile station 12 for network-initiated packet delivery. More particularly, the network 10 attempts to connect the target PCF 18 supporting the packet zone in which the mobile station 12 responds to the network's reactivation paging to the mobile station's source PDSN 20, such that the existing connections at the source PDSN 20 can be used for the reactivated packet data service.

In support of the reactivation-triggered dormant mobile station handoff taught herein, the network 10 generally passes address information for the source PDSN 20 to the target PCF 18 as part of the reactivation process. Such address information comprises, for example, the IP address of the source PDSN 20. Sending the source PDSN's IP address increases the probability that the target PCF 18 re-establishes packet data service to the mobile station 12 through the source PDSN 20, rather than through some other PDSN 20 that might, for example, be selectable by the target PCF according to a defined PDSN selection algorithm.

Again, the prefix term “source” as used herein generally means an entity last associated with providing active packet data service to the mobile station 12, and the prefix term “target” as used herein generally means an entity associated with the packet zone where the mobile station 12 is being reactivated for network-initiated packet data delivery. However, it should be noted that the source and target terminology adopted herein does not exclude the possibility that one or more source and target entities are the same.

Returning to FIG. 3, the network 10 may be configured to pass the source PDSN's P-P address to the target PCF as part of the address information passed for the source PDSN. The P-P address is useful if the target PCF 18 cannot connect directly to the source PDSN 20. In such instances, the target PCF 18 may pass the P-P address for the source PDSN 20 to a target PDSN 20. In turn, the target PDSN 20 may use the P-P address to establish a P-P connection with the source PDSN 20, thereby allowing reactivation of packet data service to the mobile station 12 at the source PDSN 20.

Further, the network 10 may be configured to pass the source PCF's Access Network ID (ANID) to the target PCF 18. When the target PCF 18 sends a registration message for the mobile station 12 being reactivated, it can include the ANID information for the source PCF, as well as including a Current Access Network Identifier (CANID) set to its own identifier. Sending the source PCF's ANID (such as in the form of a “Previous” ANID or PANID) allows the source PDSN 20 to recognize that it has a preexisting connection for the mobile station 12 at the current source PCF 20. Such recognition prevents the source PDSN 20 from initiating PPP re-negotiations if the target PCF 18 directly or indirectly connects to the source PDSN 20 for reactivation of packet data service to the mobile station 12.

Further, as noted, the source PDSN 20 may initiate reactivation paging of the mobile station 12 by sending one or more empty data frames to the source PCF 18, while buffering the actual incoming packet data for the mobile station at the source PDSN 20. In response, the source base station 16/source PCF 18 sends a request to the MSC 24 to initiate paging of the mobile station 12. Note that in cdma2000 1× networks, MSCs 24 are involved in mobility management. As part of the paging request, the source base station 16 forwards reactivation information to the MSC 24. Such reactivation information includes any one or more of the following items: the IP address of source PDSN 20, the P-P address of the source PDSN 20, and the ANID of the source PCF 18. In response, the MSC 24 sends a paging request message to one or more base stations 16 (e.g., paging request messages may be sent to the source base station 16 and one or more neighboring base stations 16).

Assuming that one of the neighboring base stations 16 receives the reactivation paging response from the mobile station 12, the MSC 24 is configured to provide all or part of the aforementioned reactivation information to that base station 16, which is considered the target base station 16. In turn, the target base station 16 provides all or part of the reactivation information to its target PCF 18. The target PCF 18 may then perform PDSN selection according to Steps 106-116 shown in FIG. 2.

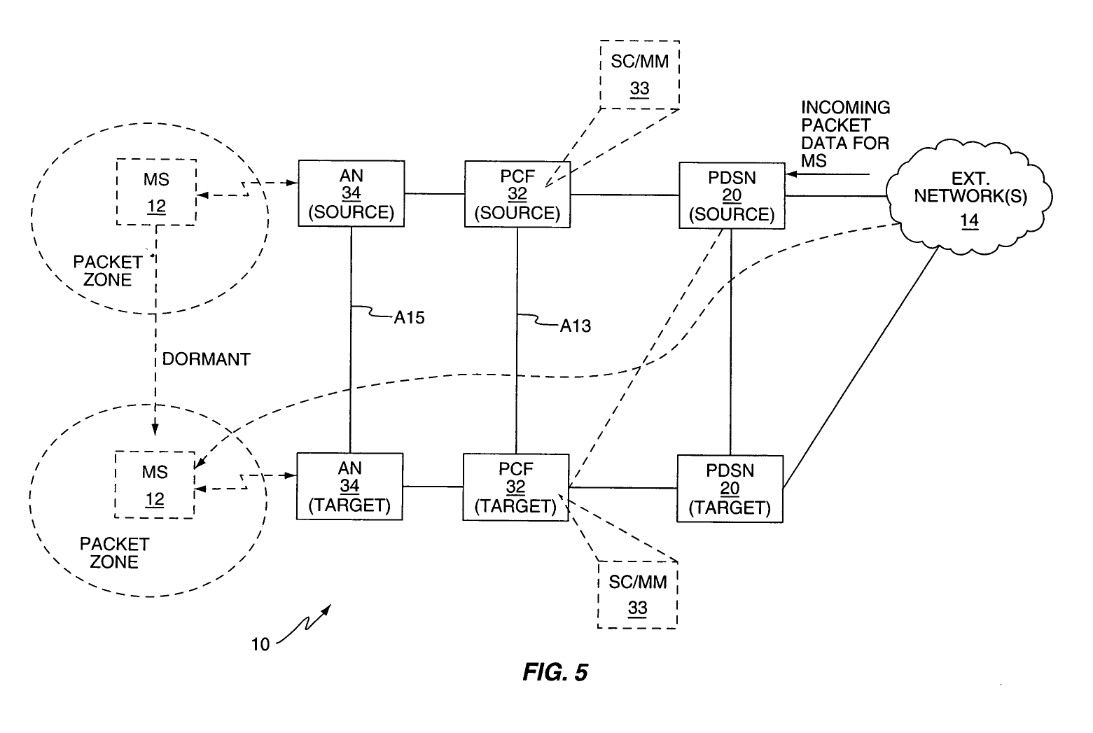

FIG. 4 illustrates a cdma2000 1× call flow in which a dormant mobile station 12 was last associated with a source base station 16, source PCF 18, and source PDSN 20, but responds to the network's reactivation paging in a packet zone associated with a different target base station 16 and target PCF 18. Note that the target PCF 18 may have connectivity with a target PDSN 20 and may have connectivity, directly or indirectly, with the source PDSN 20. With this in mind, call flow processing begins with the source PDSN 20—the PDSN where the dormant mobile station 12 is currently registered—receiving incoming packet data for the mobile station 12.

Upon receiving incoming packet data from the network 14, the source PDSN 20 at Step (a) sends a General Routing Encapsulation (GRE) frame containing no user data to the corresponding source PCF 18 on an existing PPP connection and A10 connection associated with the targeted dormant mobile station 12. The source PDSN 20 buffers the actual incoming data received from the network 14 and awaits an A11-Registration Request or a P-P Registration Request Message for the mobile station 12 containing an “active start” airlink record.

In response to receiving the empty GRE frame, the source PCF 18 sends a corresponding message to the source base station 16 to initiate reactivation paging of the mobile station, and sends source PDSN address information to the source base station 16 as part of, or in association with, such messaging. No explicit PCF-to-base station signaling step is shown in the illustrated call flow because, by way of non-limiting example, it is assumed that the source PCF 18 is co-located (or integrated with) the source base station 16. Such integration may or may not be true for the target base station 16 and target PCF 18.

In general, the source PDSN address information is sent in the form of a request reactivation for the packet data service instance for which data was received at the source PDSN 20. For example, if an A9 interface is used between the source PCF 18 and the source base station 16, the source PCF 18 can be configured to send an A9-BS Service Request Message to the source base station 16 that includes source PDSN address information. Advantageously, the source PCF 18 can be configured to send one or more of the following items as part of providing the source base station 16 with reactivation information: a SR_ID that identifies the packet data service instance to be reactivated, the IP address of the source PDSN 20, the P-P address of the source PDSN 20, and the ANID of the source PCF 18.

In response to the source PCF's messaging, the source base station 16 at Step (b) sends a BS Service Request message to a supporting MSC 24. The BS Service Request message includes some or all of the address information for the source PDSN 20. In particular, the reactivation information transmitted from the source base station 16 to the MSC 24 to initiate reactivation paging of the mobile station 12 may comprise one or more of the following items: the SR_ID identifying the packet data service instance to be reactivated, the source PDSN's IP address, the source PDSN's P-P address, and the source PCF's ANID.

Upon receiving the source base station's message, the MSC 24 at Step (c) stores the received reactivation information and acknowledges the call setup request by sending a BS Service Response message to the source base station 16. Further, the MSC 24 at Step (d) sends a Paging Request message to the target base station 16 to initiate reactivation paging by the target base station 16. In general, it should be understood that the MSC 24 sends the Paging Request message to the source base station 16 and to any number of additional, possibly neighboring, base stations 16. For example, the MSC 24 may initiate flood paging at base stations 16 and may expand flood paging as needed to reach the mobile station 12.

In any case, the target base station 16 issues a Page message containing the mobile station's address over the Paging Channel at Step (e) in response to receiving the MSC's Paging Request message. At Step (f), the mobile station 12 acknowledges the page by transmitting a Page Response message over the access channel. The target base station 16, which may be associated with a different PCF than the source PCF 18, indicates its receipt of the mobile station's Page Response message at Step (g) by sending a Paging Response message to the MSC 24. Further, the target base station 16 acknowledges the receipt of the mobile station's Page Response message at Step (h) with a BS Ack order to the mobile station 12.

Continuing with reactivation processing, the MSC 24 sends an Assignment Request message at Step (i) to the target base station 16 to request assignment of radio resources and the A8 (User Traffic) connection between the target base station 16 and the target PCF 18. The MSC 24 can be configured to send at least some of the reactivation information it received from the source base station 16 to the target base station 16 as part of sending the Assignment Request message. For example, the MSC 24 may include the source PDSN's IP address, the source PDSN's P-P address (if available), and the source PCF's ANID.

Broadly, it should be understood that the MSC 24 generally will be configured to provide such reactivation information to whichever one of the base stations 16 involved in reactivation paging of the mobile station indicates receipt of the mobile station's Page Response message. In that manner, the particular PCF 18 supporting the packet zone in which the mobile station 12 responded can be provided with the reactivation information for use in reactivating packet data service to the mobile station 12 through the source PDSN 20.

Returning to the call flow, the target base station 16 at Step (j) sets up a traffic channel with the mobile station 12 in response to receiving the Assignment Request message from the MSC 24. That is, upon receipt of the Assignment Request message from the MSC 24, the target base station 16 cooperates with the mobile station 12 to perform a radio resources setup procedure, and uses the SR_ID received from the MSC 24 to identify the packet data service instance to be reactivated. Note that if the A9 interface is used, the target base station 16 sends an A9-Setup-A8 message to the target PCF 18 to establish an A8 (User Traffic) connection between the target base station 16 and the target PCF 18. Notably, the target base station 16 can be configured to include the reactivation information as received from the MSC 24 in this message. For example, the target base station 16 may send the following information to the target PCF 18: the source PSDN's IP address, the source PSDN's P-P address (if available), and the source PCF's ANID.

In response to receiving such messaging from the target base station 16, the target PCF 18 at Step (k) sends an A11-Registration Request message to the source PDSN 20 (as identified by the PDSN address received from the MSC 24 via the target base station 16). The registration message can include an ANID NVSE with the PANID field set to the source PCF's ANID and the CANID field set to the target PCF's ANID. Based on its receipt of such information, the source PDSN 20 recognizes the mobile station as being currently registered with it, and thus reactivates packet data service to the mobile station using the preexisting PPP and A10 connections.

The source PDSN 20 at Step (I) sends an A11-Registration Reply message to the target PCF 18 as part of completing re-registration of the mobile station 12 with the source PDSN 20. The target base station 16 at Step (m) sends a corresponding Assignment Complete message to the MSC 24, and the PPP connection is reactivated at Step (n) between the source PDSN 20 and the mobile station 12 through the target PCF 18.

Of course, network connectivity may limit the target PCF's ability to register the mobile station directly with the source PDSN 20. For example, the source PDSN 20 may not be reachable by the target PCF 18, or the source PDSN 20 may for various reasons deny the registration attempt by the target PCF 18. In any case, if the target PCF 18 cannot reach the source PDSN 20, it selects another PDSN (e.g., a supporting target PDSN 20) and sends an A11-Registartion Request message to the target PDSN 20. Notably, the target PCF 18 is configured to include the source PDSN's P-P address in that registration message. In turn, the target PDSN 20 uses the P-P address to establish a P-P connection with the source PDSN 20 for reactivation of packet data service to the mobile station 12 at the source PDSN 20 through the target PDSN 20 and the target PCF 18.

Thus, if the target PCF 18 can reactivate packet data service for the mobile station 12 at the source PDSN 20 directly or indirectly, the source PDSN 20 begins forwarding the packet data incoming to the network 10 for the mobile station 12 to the target PCF 18. As such, and assuming that the source PDSN 20 initiated reactivation paging by sending an empty GRE frame to the source PCF 18 rather than sending actual user data, there is no loss of packet data even though the mobile station 12 is reactivated in a packet zone different from the packet zone where it was last active.

However, if the target PCF 18 cannot directly or indirectly reach the source PDSN 20, the target PDSN 20 initiates PPP negotiations for the mobile station 12. The mobile station 12 thus initiates a new Simple IP session or Mobile IP (MIP) registration. The initial incoming packet data that was sent to the source PDSN 20 generally is lost.

Reactivation-triggered handoff as taught herein may also be used in HRPD EV-DO architecture systems that support paging across multiple packet zones, as provided by, e.g., the A15 interface. The standards document A.S0007-A specifies the interoperability specification for HRPD network access interfaces and it should be noted that this architecture does not use MSCs. Instead, the PCFs include a mobility management entity, e.g., a SC/MM entity. Additionally, the base stations are referred to as Access Nodes (ANs) and are linked by A15 interfaces. The PCFs are linked via A13 interfaces.

Thus, in embodiments of the network 10 based on an HRPD architecture, reactivation information (e.g., source PDSN IP address, source PDSN P-P address, source PCF ANID) is not passed on the A1 interface of an MSC. Instead, the A15 interfaces linking ANs are used for paging and the A13 interfaces are used for providing the reactivation information to the target PCF supporting the packet zone in which the mobile station 12 responds to paging by the ANs.

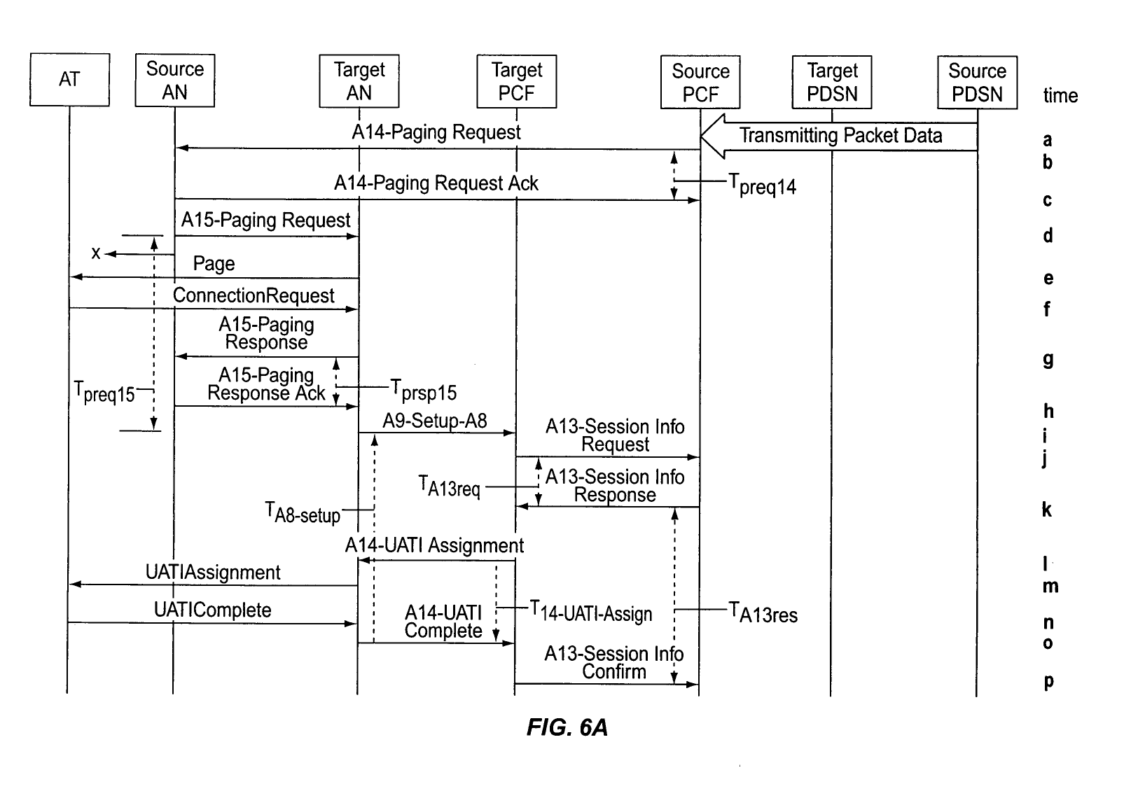

FIG. 5 illustrates a HRPD embodiment of the network 10. Incoming data from the network 14 for a given mobile station 12 is buffered at a source PDSN 30. The source PDSN 30 sends a “reactivation packet” to a selected, source PCF 32 to initiate re-activation of the mobile station's packet data session. The source PCF 32 uses its included session control/mobility management (SC/MM) entity 33 to identify the source AN 34 for initiating paging. Assuming that the mobile station 12 has moved from the coverage area of the source AN 34 while dormant, the source AN 34 uses the A15 interface to initiate paging requests at one or more neighboring ANs 34. Assuming the illustrated target AN 34 is the one that the mobile station 12 responds to, the target AN 34 sets up a connection for the mobile station 12 with the target PCF 32.

For example, the source AN 34 may comprise or include a controller (e.g., one or more processing circuits) that are configured to send address information for the source PDSN in conjunction with initiating reactivation paging of a mobile station by one or more additional AN controllers for network-initiated packet data delivery. In turn, the target AN 34 may comprise or include a controller that is configured to provide all or part of such information in conjunction with sending a connection setup request to the target PCF (in response to receiving the mobile station's paging response).

In turn, the target PCF 32 uses its A13 interface to retrieve session information and reactivation information (e.g., source PDSN IP address, source PDSN P-P address, and source PCF ANID) for the mobile station 12. Assuming for the sake of example that the target PCF 32 cannot connect with the source PDSN 30, the target PCF 32 sets up a connection with the target PDSN 30 and relays the source PDSN P-P address to the target PDSN 30. The target PDSN 30 uses the P-P address to set up a P-P connection to the source PDSN 30. The buffered data at the source PDSN 30 is then forwarded to the mobile station 12 via the target PDSN 30, target PCF 32, and target AN 34.

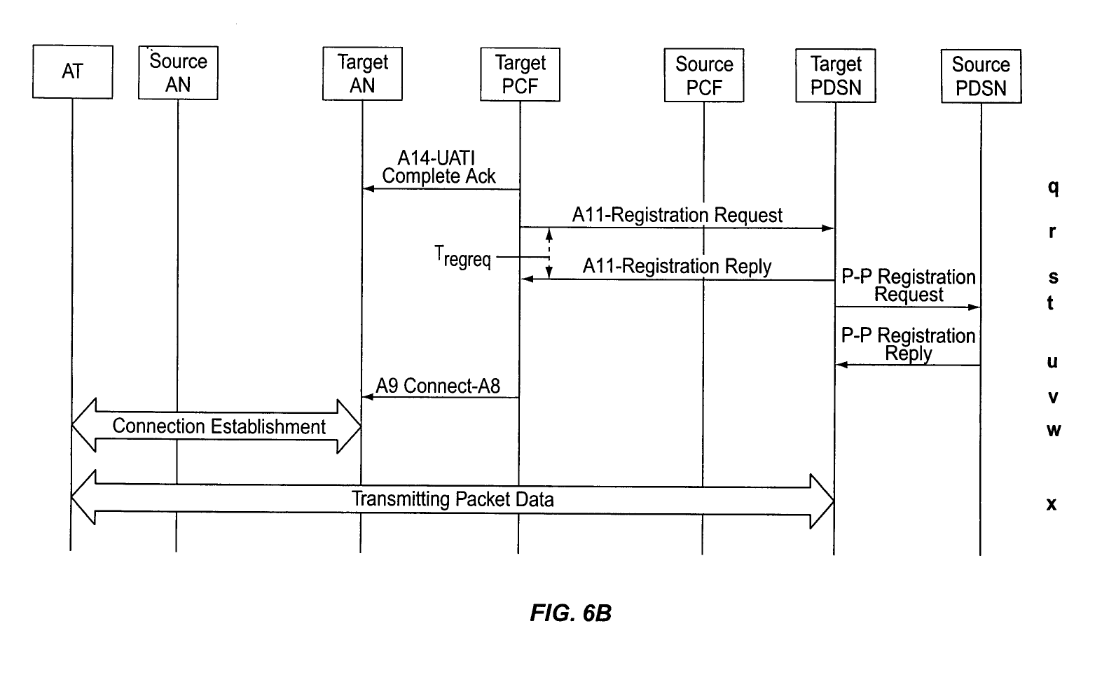

FIGS. 6a and 6b further details at least one embodiment of HRPD-related processing. In the illustrated call flow, processing begins at Step (a) with the source PDSN sending packet data to the source PCF. In response, at Step (b), the source PCF sends an A14-Paging Request message to the source AN.

Processing continues at Step (c) with the source AN sending an A14-Paging Request Ack message to the source PCF. For inter-AN paging, and unless the A15 Paging Inhibited indicator bit was set by the source PCF in the A14-Paging Request message, the source AN at Step (d) sends an A15-Paging Request message to one or more target ANs. The source and target ANs each send a Page message for the mobile station 12 at Step (e). In the illustrated call flow, the target AN rather than the source AN receives the mobile station's paging response—i.e., the mobile station 12 sends a Connection Request message to the target AN at Step (f).

At Step (g), the target AN sends an A15-Paging Response message to the source AN, and the source AN responds with an A15-Paging Response Ack message at Step (h). Processing continues at Step (i) with the target AN sending an A9-Setup-A8 message to the target PCF with the Data Ready Indicator set to ‘1’ to establish the A8 connection. Additionally, the target AN1 includes the Session Information Required Indicator, set to ‘1’, in the A9-Setup-A8 message if it does not have all of the session information.

At Step (j), the target PCF initiates determination of the UATI of an existing HRPD session, if any such information is available. The target PCF uses the UATI as an identifier for an existing HRPD session as part of its attempt to retrieve existing HRPD Session state information from the source PCF. To that end, the target PCF requests HRPD session information for the mobile station 12 by sending an A13-Session Information Request message to the source PCF.

Processing continues at Step (k) with the source PCF returning the requested HRPD session information in an A13-Session Information Response message. Then, at Step (I), the target PCF sends an A14-UATI Assignment message to the target AN and, at Steps (m) and (n), the mobile terminal 12 and the target AN complete the establishment of the HRPD session. At Step (o), the target AN sends an A14-UATI Complete message to the target PCF indicating that the UATI assignment was successful and, at Step (p), the target PCF sends an A13-Session Information Confirm to the source PCF to indicate reception of the HRPD session information by the target PCF. At Step (q) the target PCF then sends an A14-UATI Complete Ack message to the target AN responsive to its receipt of the A14-UATI Complete message.

Assuming that that source PDSN is not reachable by the target PCF, the target PCF may nonetheless take advantage of the source PDSN's connection for the mobile station 12 by sending an A11-Registration Request message to the target PDSN that includes the source PDSN's P-P address at Step (r). The target PDSN returns an A11-Registration Reply message in return at Step (s), and then uses the source PDSN's P-P address to establish a P-P connection with the source PDSN by sending a P-P Registration Request message to the source PDSN at Step (t) and receiving a P-P Registration Reply message at Step (u).

Processing continues at Step (v) with the target PCF sending an A9-Connect-A8 message to the target AN, and at Step (w) with the target AN establishing an air interface connection with the mobile station 12 for the transmission of packet data at Step (x).

Thus, whether applied to a cdma2000 1× embodiment, an HRPD embodiment, or to some other packet data network embodiment, the network 10 is configured to perform reactivation-triggered handoff of a given dormant mobile station 12 as part of network-initiated packet data delivery. To that end, the source entities last associated with actively serving the mobile station 12 initiate reactivation paging and provide reactivation information, such as source PDSN IP and P-P addresses, for use by the target entities in reactivating packet data service to the mobile station 12.

As explained for cdma2000 1× embodiments, a source PCF 18 is configured to provide source PDSN IP and P-P addresses to a source base station 16 as part of reactivation paging. In turn, the source base station 16 is configured to provide a MSC 24 with reactivation information comprising, for example, the source PDSN IP and P-P addresses, and the source PCF's ANID. The MSC 24 is configured to provide that information to a target base station 16, which is defined as the base station 16 that receives the mobile station's paging response. The target base station 16 is configured to provide the reactivation information to an associated, target PCF 18. In turn, the target PCF 18 is configured to use the information to connect directly or indirectly to the source PDSN 20.

A similar scenario plays out for the HRPD embodiments, but involves similarly configured PDSNs 30, PCFs 32, and ANs 34. In such embodiments, ANs 34 manage paging and SC/MMs 33 within PCFs 32 manage the distribution of reactivation information.

In any case, making source PDSN and source PCF information available as part of reactivation paging allows the network 10 to avoid performing dormant handoffs of dormant mobile stations 12 as they move between packet zones of the network 10. Instead, for network-initiated packet data delivery, the network 10 simply provides reactivation information to the target PCF supporting the particular packet zone in which the mobile station responds to reactivation paging. This operation allows the target PCF to connect with the source PDSN and thereby preserve the mobile station's existing PPP and A10 connections.

With the above range of variations in mind, it should be understood that the present invention is not limited by the foregoing description, nor is it limited by the accompanying drawings. Instead, the present invention is limited only by the following claims, and their legal equivalents.

What is claimed is:

1. A method of reactivating packet data service to dormant mobile station for packet data delivery by a wireless communication network comprising one or more packet zones, the method comprising:
initiating reactivation paging of the mobile station responsive to receiving incoming packet data for the mobile station at a source Packet Data Serving Node (PDSN) last associated with serving the mobile station;
providing address information for the source PDSN to a target Packet Control Function (PCF), said target PCF being the PCF supporting the packet zone in which the mobile station responded to the reactivation paging; and
using the address information at the target Packet Control Function (PCF) to select, if network connectivity permits, the source PDSN for reactivation of packet data service to the mobile station.

2. The method of claim 1, wherein initiating reactivation paging of the mobile station comprises sending one or more empty data frames from the source PDSN to a source PCF last associated with serving the mobile station, while buffering the incoming packet data for subsequent delivery to the mobile station upon its reactivation.

3. The method of claim 1, wherein providing address information for the source PDSN comprises sending the address information from a source PCF last associated with serving the mobile station to a corresponding source base station, from the source base station to a Mobile Switching Center (MSC) supporting reactivation paging of the mobile station, from the MSC to a target base station, and from the target base station to the target PCF, said target base station being the base station that receives a reactivation paging response from the mobile station.

4. The method of claim 1, wherein using the address information at the target Packet Control Function (PCF) comprises reactivating packet data service to the mobile station at the source PDSN via the target PCF, if the source PDSN is reachable by the target PCF.

5. The method of claim 4, wherein using the address information at the target Packet Control Function (PCF) comprises reactivating packet data service to the mobile station at the source PDSN through a target PDSN having a PDSN-to-PDSN connection with the source PDSN, if the source PDSN is not reachable by the target PCF but is reachable by the target PDSN.

6. The method of claim 5, wherein using the address information at the target Packet Control Function (PCF) comprises establishing new packet data service for the mobile station at the target PDSN if the source PDSN is not reachable by the target PCF or by the target PDSN.

7. A method of reactivating packet data service to a dormant mobile station for packet data delivery by a wireless communication network comprising one or more packet zones, the method comprising:
receiving address information for a source Packet Data Serving Node (PDSN) last associated with serving the mobile station at a target Packet Control Function (PCF) supporting the packet zone in which the mobile station responded to reactivation paging by the wireless communication network; and
selecting the source PDSN as identified by the received address information for reactivation of packet data service to the mobile station if network connectivity permits.

8. The method of claim 7, wherein the received address information comprises an IP address of the source PDSN, and wherein selecting the source PDSN comprises sending a registration message for the mobile station from the target PCF to the source PDSN according to the IP address, if the source PDSN is reachable by the target PCF.

9. The method of claim 8, further comprising including a previous network identifier for a source PCF last associated with serving the mobile station and a current network identifier for the target PCF in the registration message, thereby allowing the source PDSN to recognize that the mobile station is being reactivated in a packet zone different from the packet zone last associated with serving the mobile station.

10. The method of claim 7, wherein the received address information comprises a P-P address of the source PDSN, and wherein selecting the source PDSN comprises sending a registration message for the mobile station from the target PCF to a target PDSN, if the source PDSN is not reachable by the target PCF, said registration message including a P-P address of the source PDSN for use by the target PDSN in communicating with the source PDSN for reactivation of packet data service to the mobile station through the source PDSN.

11. The method of claim 10, further comprising activating a new packet data service for the mobile station through the target PDSN and the target PCF, rather than reactivating packet data service through the source PDSN, if the source PDSN is not reachable by the target PDSN.

12. The method of claim 7, further comprising providing the address information for the source PDSN to a source base station associated with a source PCF last associated with serving the mobile station and sending the address information from the source base station to a Mobile Switching Center (MSC) as part of initiating reactivation paging of the mobile station.

13. The method of claim 7, further comprising sending the address information from the MSC for receipt by the target PCF in response to receiving an indication that the mobile station responded to reactivation paging in the packet zone of the target PCF.

14. The method of claim 13, wherein the address information sent to the MSC includes a previous network identifier for the source PCF, and wherein the MSC includes the previous network identifier in the address information it sends for receipt by the target PCF.

15. The method of claim 7, further comprising providing the address information for the source PDSN to a source base station associated with a source PCF last associated with serving the mobile station and sending the address information from a mobility management entity of the source PCF to a mobility management entity of the target PCF.

16. The method of claim 7, further comprising initiating the reactivation paging of the mobile station in response to receiving incoming packet data for the mobile station at the source PDSN based on buffering the incoming data and sending one or more empty data frames to a source PCF last associated with serving the mobile station.

17. The method of claim 16, further comprising sending the buffered incoming data from the source PDSN for delivery to the mobile station through the target PCF.

18. The method of claim 7, wherein the address information for the source PDSN is received in or in conjunction with receiving a connection setup request for the mobile station from a target Access Network (AN) associated with the target PCF.

19. The method of claim 18, further comprising determining that the connection setup request indicates that the mobile station was most recently associated with a source PCF different from the target PCF and requesting call session information from the source PCF responsive to said determining.

20. The method of claim 19, wherein determining that the connection setup request indicates that the mobile station was most recently associated with a source PCF different from the target PCF comprises basing said determining on a Unicast Access Terminal Identifier (UATI) included in the connection setup request.

21. The method of claim 19, wherein requesting call session information from the source PCF responsive to said determining comprises sending an A13-Session Info Request message from the target PCF to the source PCF, and receiving an A13-Session Info Response message from the source PCF at the target PCF.

22. The method of claim 21, wherein P-P address information for the source PDSN is included in the A-13 Session Info Response message, and wherein selecting the source PDSN as identified by the received address information for reactivation of packet data service to the mobile station if network connectivity permits comprises sending the P-P address information to a target PDSN associated with the target PCF, for establishment of a PDSN-to-PDSN connection between the source and target PDSNs.

23. The method of claim 18, wherein the connection setup request comprises an A9-Setup-A8 message from the target AN to the target PCF.

24. A Packet Control Function (PCF) for use in a wireless communication network, said PCF comprising one or more processing circuits configured to receive address information for a source Packet Data Serving Node (PDSN) last associated with serving a mobile station as part of reactivating the mobile station for network-initiated packet data delivery, and further configured to select the source PDSN as identified by the received address information for reactivation of packet data service to the mobile station if network connectivity permits.

25. An Access Network (AN) controller for use in a wireless communication network, said AN controller comprising one or more processing circuits configured to send address information for a source Packet Data Serving Node (PDSN) in conjunction with initiating reactivation paging of a mobile station by one or more additional AN controllers for network-initiated packet data delivery.

26. A Packet Data Serving Node (PDSN) for use in a wireless communication network, said PDSN comprising one or more processing circuits configured to send address information, including at least one of its routing address and its P-P address, to an associated source Packet Control Function (PCF) to support reactivation of a mobile station for network-initiated packet data delivery.
